(19) United States
(12) Patent Application Publication
(10) Pub. No.: US 2006/0216575 A1
(43) Pub. Date: Sep. 28, 2006

(54) Perovskite materials with combined Pr, La, Sr, "A" site doping for improved cathode durability

(75) Inventor: Mark Cassidy, St. Andrews (GB)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/384,426

(22) Filed: Mar. 21, 2006

Related U.S. Application Data
(60) Provisional application No. 60/664,294, filed on Mar. 23, 2005.

(51) Int. Cl. H01M 4/90; H01M 8/12; C04B 35/00; C01G 49/00

(52) U.S. Cl. 429/40; 429/30; 501/126; 423/594.1

(57) ABSTRACT

A solid oxide fuel cell cathode electrode is made from an AₙBₘO₃ ceramic material, where A comprises Pr, La and Sr, and B comprises Fe and optionally at least one of Co and Mn. Preferably, the material is A-site deficient.

### BACKGROUND OF THE INVENTION

This application claims benefit of priority of U.S. Provisional Application Ser. No. 60/664,294, filed on Mar. 23, 2005, which is incorporated herein by reference in its entirety.

The present invention is generally directed to fuel cells and more specifically to solid oxide fuel cells.

Fuel cells are electrochemical devices which can convert energy stored in fuels to electrical energy with high efficiencies. A solid oxide fuel cell (SOFC) generates electrical energy and reactant product from fuel and oxidizer. The SOFC contains a ceramic electrolyte, a negative or fuel electrode and a positive or oxygen electrode. The electrolyte is usually yttria stabilized zirconia (“YSZ”). The negative or fuel electrode (referred hereto as the “anode” electrode) is usually made entirely of a noble metal (e.g. platinum), contains a large amount of a noble metal or is made from a cermet, such as a nickel-YSZ cermet. The positive or oxygen electrode (referred hereto as the “cathode” electrode) is usually made of a ceramic perovskite material, such as lanthanum strontium manganite (“LSM”) having a formula (La,Sr)MnO₃ or lanthanum strontium cobaltite (“LSCo”) having a formula (La,Sr)CoO₃. A major drawback of lanthanum based perovskite ceramics is their degradation through the formation of insulating layer of a lanthanum zirconate pyrochlore upon the reaction with the YSZ electrolyte.

### SUMMARY

An embodiment of the invention provides a solid oxide fuel cell cathode electrode which is made from an AₙBₘO₃ ceramic material, where A comprises Pr, La and Sr, and B comprises Fe and optionally at least one of Co and Mn.

### BRIEF DESCRIPTION OF THE DRAWING

FIG. 1 shows a schematic cross sectional view of a solid oxide fuel cell according to an embodiment of the present invention. The drawing is not to scale.

### DETAILED DESCRIPTION OF THE PREFERRED EMBODIMENTS

The present inventor realized that praseodymium, strontium and iron containing perovskite ceramic materials may be used as durable cathode electrodes in SOFCs. One feature of praseodymium based materials is that their reaction product with zirconia, praseodymium zirconate, does not form an insulating layer as is the case with other lanthanide cations. In contrast, the reaction product remains catalytically active for the oxygen reduction reaction and its presence does not necessarily mean catastrophic cathode degradation. Thus, the cathode electrode may be formed from a reactive material directly on the YSZ electrolyte. Furthermore, these materials are also good electrocatalysts as they exhibit a level of mixed (i.e., ionic and electrical) conductivity.

In one embodiment of the invention, the inventor realized that praseodymium and lanthanum may be used together on the A-site of a perovskite to realize benefits of both. The presence of the praseodymium will reduce cathode degradation rates, specifically as it can form praseodymium zirconate if it reacts with YSZ which is still catalytically active for the oxygen reduction reaction.

However it has been observed that cathodes utilizing just Pr on the A-site have a tendency to sinter more than lanthanum based counterparts thereby reducing overall cathode performance. The inventor realized that by introducing a proportion of lanthanum onto the A-site in combination with praseodymium, the amount of sintering will be reduced maintaining overall cathode performance but still realizing the benefits of the Pr on the long term durability of the cathode.

Preferably, the cathode material has the formula AₙBₘO₃ where A comprises Pr, La and Sr, and B comprises Fe and optionally one or both of Mn and Co in addition to Fe. Preferably, 0.9≦n≦1.1, 0.9≦m≦1.1. Thus, the ratio of A to B to oxygen may be 1:1:3 to provide a A₁B₁O₃, perovskite, but it preferably deviates from this ratio by 10% or less, such as by 5% or less, to form a non-stoichiometric compound in which a ratio of A to B to oxygen ranges from 0.9:1.1:3 to 1.1:0.9:3. Preferably, the overall stoichiometry of the cathode material is A-site deficient (i.e., less than one A cation is present for every one or more B cation and three oxygen anions) as this may lead to better electrode performance of the cathode material. For example, in an A-site deficient material, the ratio of A to B is less than 1, such as 0.9 to 0.99 and the ratio of A to B to oxygen preferably ranges from 0.9:1:3 to 0.99:1:3 (i.e., 0.9≦n≦0.99, m=1), preferably 0.95:1:3. An example of a non-stoichiometric perovskite is (La_{0.4}Pr_{0.4}Sr_{0.2})_{0.95}FeO₃. In this case, a portion of Fe may be substituted by Co.

Preferably, the A site cations comprise at least 25% Pr, at least 15% La and at least 20% Sr. More preferably, the A site cations comprise between 25 and 55%, such as between 30 and 50% Pr, between 15 and 40%, such as between 20 and 35% La, and between 20 and 40%, such as between 25 and 35% Sr. Preferably, the B site cation comprises at least 50% Fe and 0% to 30% of Mn and/or Co, most preferably between 80 and 100% Fe and between 0 and 20% Co. Thus, the preferred perovskite ceramic composition in this embodiment is (PrₓLa_{z}Sr_{1-x-z})_{1±0.1}(Fe_{y}CO_{1-y})_{1±0.1}O₃, where 0.25≦x≦0.55, 0.8≦y≦1.0, and 0.15≦z≦0.4. Thus, the cathode electrode comprises praseodymium lanthanum strontium ferrite.

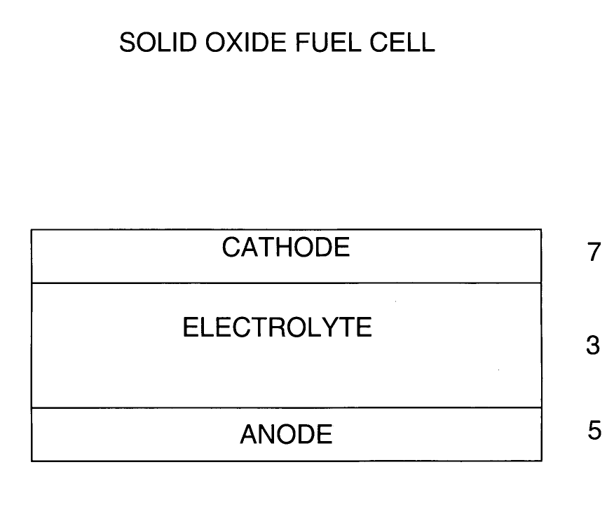

The cathode material can be used in a non-reversible or in a reversible solid oxide fuel cell with any combination of a suitable solid oxide electrolyte and an anode. A reversible fuel cell is adapted to operate in both a fuel cell (i.e., electricity generation) mode and an electrolysis (i.e., fuel generation) mode, while a non-reversible fuel cell is adapted to operate only in the fuel cell mode. FIG. 1 shows an exemplary solid oxide fuel cell. The fuel cell contains an electrolyte 3, an anode electrode 5 and a cathode electrode 7. For example, as noted above, the electrolyte may comprise YSZ and the anode may comprise a Ni-YSZ cermet and/or a noble metal, such as Pt. Furthermore, additional contact or current collector layers may be placed in contact with the anode and cathode electrodes. For example, a Ni or nickel oxide anode contact layer and an LSM or LSCo cathode contact layer may be formed on the anode and cathode electrodes, respectively. If a nickel oxide layer is formed, then it is preferably later reduced to a nickel layer.

It should be noted that the fuel cell illustrated in FIG. 1 is preferably used in a fuel cell stack which includes a plurality of electrically connected fuel cells and other components, such as gas separator / interconnect plates, seals and electrical contacts. Each gas separator/interconnect plate contacts the electrode and/or current collector layer of adjacent fuel cells. The fuel cell stack is preferably part of a larger fuel cell system which contains one or more fuel cell stacks and balance of plant components.

The fuel cell may be made by any suitable method. In one exemplary method, the electrode layers are coated on the opposite sides of the electrolyte as mixed inks made from powders and then fired at any suitable temperature. For example the anode electrode starting material comprising nickel oxide and yttria stabilized zirconia is coated onto the electrolyte and then fired at between 1300 and 1400 degrees Celsius in air, such as at 1350 degrees Celsius in air. Then the cathode layer is coated onto the electrolyte. Then, the whole fuel cell is fired at between 1100 and 1250 degrees Celsius in air, such as at 1200 degrees Celsius in air. Any suitable thicknesses may be used for layers 3, 5, 7 depending on the overall dimensions of the fuel cell. If desired, additional materials may be used in the inks such as dispersants, binders, carriers, etc, which are evaporated during the firing steps.

Table I lists some A-site deficient compositions of cathode electrodes according to comparative examples. The compositions of comparative examples contain only Pr and Sr on the A-sites and should not be presumed to be admitted prior art.

TABLE I

(Pr_{0.70}Sr_{0.25})FeO₃
(Pr_{0.65}Sr_{0.30})FeO₃
(Pr_{0.75}Sr_{0.20})FeO₃
(Pr_{0.65}Sr_{0.30})FeO₃
(Pr_{0.60}Sr_{0.35})(Fe_{0.80}Co_{0.20})O₃

Table II lists some exemplary compositions of the cathode electrodes according to the embodiments of invention. The exemplary compositions are tri-doped, A-site deficient compositions which contain Pr, Sr and La on the A-site.

TABLE II

(La_{0.35}Pr_{0.35}Sr_{0.25})FeO₃
(La_{0.20}Pr_{0.50}Sr_{0.25})FeO₃
(La_{0.30}Pr_{0.30}Sr_{0.35})(Fe_{0.80}Co_{0.20})O₃

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A solid oxide fuel cell cathode electrode comprising an AₙBₘO₃ ceramic material, where A comprises Pr, La and Sr, and B comprises Fe.

2. The fuel cell cathode of claim 1, wherein B comprises at least 50% Fe.

3. The fuel cell cathode of claim 1, wherein a ratio of A to B to oxygen ranges from 0.9:1.1:3 to 1.1:0.9:3.

4. The fuel cell cathode of claim 1, wherein 0.9≦n≦1.1 and 0.9≦m≦1.1.

5. The fuel cell cathode of claim 1, wherein a ratio of A to B is less than 1.

6. The fuel cell cathode of claim 5, wherein the ratio of A to B ranges from 0.9:1 to 0.99:1.

7. The fuel cell cathode of claim 6, wherein the ratio of A to B to oxygen is 0.9:1:3 to 0.99:1:3.

8. The fuel cell cathode of claim 1, wherein A comprises at least 25% Pr, at least 15% La and at least 20% Sr, and B comprises at least 50% Fe and 0% to 30% of at least one of Mn and Co.

9. The fuel cell cathode of claim 8, wherein A comprises between 25 and 55% Pr, between 15 and 40% La and between 20 and 40% Sr, and B comprises between 80 and 100% Fe and between 0 and 20% Co.

10. The fuel cell cathode of claim 9, wherein A consists essentially of between 30 and 50% Pr, between 20 and 35% La and between 25 and 35% Sr.

11. The fuel cell cathode of claim 1, wherein the cathode electrode material comprises (PrₓLa_{z}Sr_{1-x-z})_{1±0.1}(Fe_{y}CO_{1-y})_{1±0.1}O₃ where 0.25≦x≦0.55, 0.8≦y≦1.0, and 0.15≦z≦0.4.

12. The fuel cell cathode of claim 1, wherein the cathode electrode material comprises (PrₓLa_{z}Sr_{1-x-z})ₙ(Fe_{y}CO_{1-y})₁O₃ where 0.25≦x≦0.55, 0.8≦y≦1.0, 0.15≦z≦0.4, and 0.9≦n≦0.99.

13. The fuel cell cathode of claim 12, wherein 0.3≦x≦0.5, y=1, and 0.2≦z≦0.35.

14. The fuel cell cathode of claim 12, wherein 0.3≦x≦0.5, 0.8≦y≦1.0, and 0.2≦z≦0.35.

15. The fuel cell cathode of claim 1, wherein the cathode electrode material comprises a non-stoichiometric, A site deficient material which contains less than one A cation for each one or more B cations and for each three oxygen anions.

16. A solid oxide fuel cell comprising a solid oxide electrolyte, an anode electrode and a cathode electrode of claim 1.

17. A solid oxide fuel cell stack comprising a plurality of solid oxide fuel cells of claim 16.

18. A solid oxide fuel cell cathode electrode comprising praseodymium lanthanum strontium ferrite.

19. A solid oxide fuel cell cathode electrode comprising A-site deficient praseodymium lanthanum strontium ferrite.

20. A solid oxide fuel cell comprising a solid oxide electrolyte, an anode electrode and a cathode electrode of claim 19.
